(19) United States
(12) Patent Application Publication
(10) Pub. No.: US 2025/0297376 A1
(43) Pub. Date: Sep. 25, 2025

(54) INTER-CONNECTOR AND ELECTROCHEMICAL CELL

(71) Applicant: NGK INSULATORS, LTD., Nagoya-shi, Aichi (JP)

(72) Inventors: Takashi SHIRATORI, Nagoya-shi (JP); Toshiyuki NAKAMURA, Handa-shi (JP); Genta TERAZAWA, Nagoya-shi (JP); Makoto OHMORI, Nagoya-shi (JP)

(21) Appl. No.: 18/829,703

(22) Filed: Sep. 10, 2024

Related U.S. Application Data
(63) Continuation of application No. PCT/JP2024/010778, filed on Mar. 19, 2024.

(51) Int. Cl. C25B 9/60; C25B 15/08

(52) U.S. Cl. CPC C25B 9/60; C25B 15/08

(57) ABSTRACT

The present inter-connector includes a body, a first oxide layer, and a second oxide layer. The body includes a first principal surface and a second principal surface. The second principal surface is opposite to the first principal surface. The first oxide layer is disposed on the first principal surface. The second oxide layer is disposed on the second principal surface. The second oxide layer is different in thickness from the first oxide layer.

### CROSS-REFERENCE TO RELATED APPLICATIONS

This is a continuation of PCT/JP2024/010778, filed Mar. 19, 2024, the entire contents of which are hereby incorporated by reference.

### TECHNICAL FIELD

The present invention relates to an inter-connector and an electrochemical cell.

### BACKGROUND ART

Supporting a cell body by a metallic substrate has been known as a structure for an electrochemical cell such as an electrolytic cell, a fuel cell, or so forth. For example, an electrochemical cell disclosed in WO2018/181926 A1 is structured such that an electrode layer, an electrolyte layer, and a counter electrode layer are laminated on a metallic substrate in this order. The metallic substrate includes a plurality of through holes for supplying raw material gas to the electrode layer.

The electrochemical cell includes an inter-connector serving as a channel for the raw material gas to be supplied to the cell body. The inter-connector includes protrusions and recesses formed on the surface thereof by processing such as embossing or slitting.

### SUMMARY OF THE INVENTION

### Technical Problems

The inter-connector has been demanded to be warped from the perspective of, for instance, ensuring contact thereof with a contacted object. However, the inter-connector includes the protrusions and recesses; hence, it has been difficult for the inter-connector to be warped by processing such as stamping.

It is an object of the present invention to warp an inter-connector.

### Solution to Problems

An inter-connector according to a first aspect includes a body, a first oxide layer, and a second oxide layer. The body includes a first principal surface and a second principal surface. The second principal surface is opposite to the first principal surface. The first oxide layer is disposed on the first principal surface. The second oxide layer is disposed on the second principal surface. The second oxide layer is different in thickness from the first oxide layer.

According to the configuration, the first and second oxide layers are different in thickness from each other; hence, the inter-connector can be warped by a thermal stress generated therein.

Specifically, when each of the first and second oxide layers is set to be smaller in thermal expansion coefficient than the body, while the first oxide layer is made smaller in thickness than the second oxide layer, the inter-connector can be warped to protrude at the middle thereof toward the second oxide layer. By contrast, when each of the first and second oxide layers is set to be smaller in thermal expansion coefficient than the body, while the first oxide layer is made larger in thickness than the second oxide layer, the inter-connector can be warped to protrude at the middle thereof toward the first oxide layer. Alternatively, when each of the first and second oxide layers is set to be larger in thermal expansion coefficient than the body, while the first oxide layer is made smaller in thickness than the second oxide layer, the inter-connector can be warped to protrude at the middle thereof toward the first oxide layer. By contrast, when each of the first and second oxide layers is set to be larger in thermal expansion coefficient than the body, while the first oxide layer is made larger in thickness than the second oxide layer, the inter-connector can be warped to protrude at the middle thereof toward the second oxide layer.

An inter-connector according to a second aspect relates to the inter-connector according to the first aspect and is configured as follows.

The body is made of an alloy containing chromium. Each of the first and second oxide layers contains chromium as a primary component thereof.

An inter-connector according to a third aspect relates to the inter-connector according to the first or second aspect and is configured as follows. Each of the first and second oxide layers is smaller in thermal expansion coefficient than the body.

An inter-connector according to a fourth aspect relates to the inter-connector according to the third aspect and is configured as follows. The first oxide layer is smaller in thickness than the second oxide layer.

An inter-connector according to a fifth aspect relates to the inter-connector according to any of the first to fourth aspects and is configured as follows. The body includes a protrusion on the first principal surface thereof. The first oxide layer formed on the protrusion is smaller in thickness than the first oxide layer formed on a part other than the protrusion.

An electrochemical cell according to a sixth aspect includes the inter-connector recited in any of the first to fifth aspects, a support substrate, and a cell body. The support substrate is attached to the inter-connector. The cell body is disposed on the support substrate.

An electrochemical cell according to a seventh aspect relates to the electrochemical cell according to the sixth aspect and is configured as follows. Each of the first and second oxide layers is smaller in thickness than the cell body.

### Advantageous Effects of Invention

According to the present invention, an inter-connector can be warped.

### BRIEF DESCRIPTION OF THE DRAWINGS

FIG. 1 is a plan view of an electrolytic cell.

FIG. 2 is a cross-sectional view of the electrolytic cell taken along line II-II in FIG. 1.

FIG. 3 is a plan view of an inter-connector.

FIG. 4 is an enlarged cross-sectional view of the inter-connector.

FIG. 5 is an enlarged cross-sectional view of the inter-connector.

FIG. 6 is a plan view of an inter-connector according to a modification.

### DESCRIPTION OF EMBODIMENTS

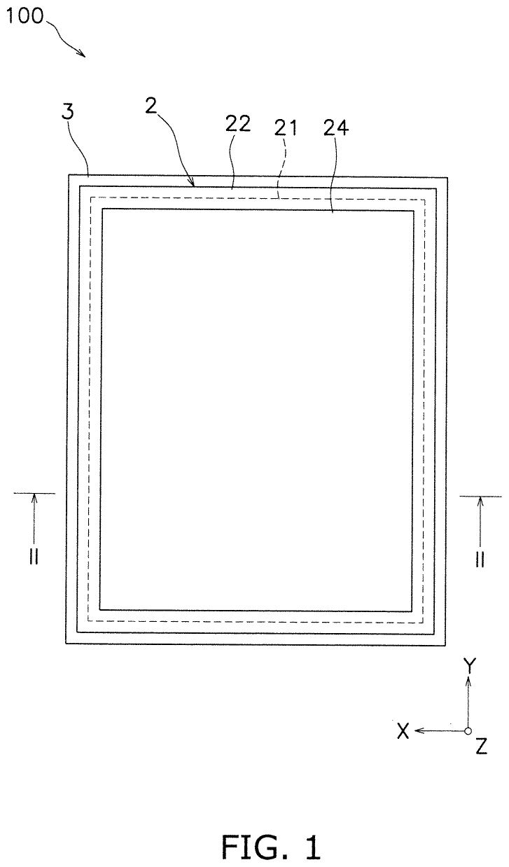

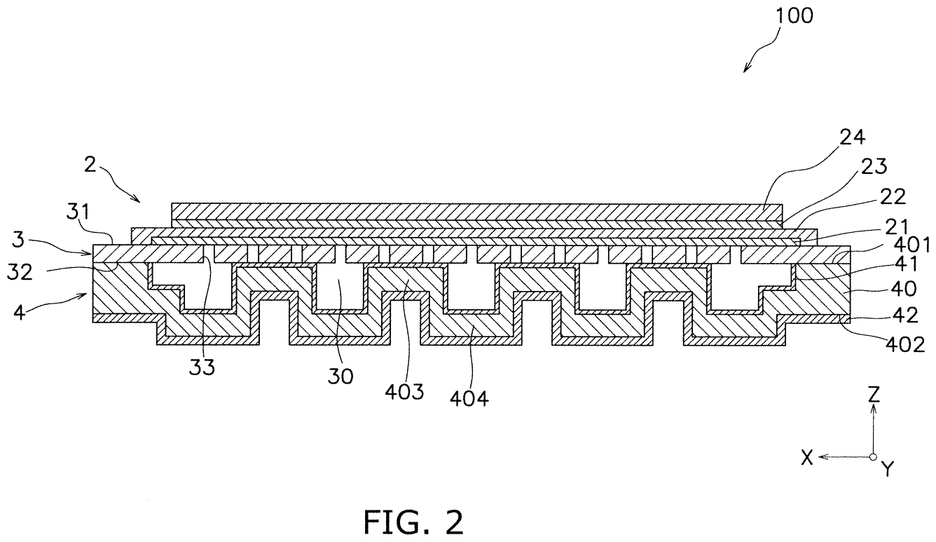

An electrolytic cell 100 (exemplary electrochemical cell) according to the present preferred embodiment will be hereinafter explained with reference to drawings. It should be noted that in the present preferred embodiment, explanation will be made with a solid oxide electrolytic cell (SOEC) as an example of the electrolytic cell 100. FIG. 1 is a plan view of the electrolytic cell 100. FIG. 2 is a cross-sectional view of the electrolytic cell 100 taken along line II-II in FIG. 1.

### Electrolytic Cell

As shown in FIGS. 1 and 2, the electrolytic cell 100 is made in shape of a plate extending in an X-axis direction and a Y-axis direction. In the present preferred embodiment, when seen in a plan view along a Z-axis direction perpendicular to both the X-axis and Y-axis directions, the electrolytic cell 100 is made in shape of a rectangle elongated in the Y-axis direction. However, the electrolytic cell 100 is not particularly limited in planar shape; hence, the planar shape thereof may be a polygon, an ellipse, a circle, or so forth other than the rectangle. It should be noted that the Z-axis direction means the thickness direction of the electrolytic cell 100, a cell body 2, a support substrate 3, and an inter-connector 4.

As shown in FIGS. 1 and 2, the electrolytic cell 100 includes the cell body 2, the support substrate 3, and the inter-connector 4.

### Cell Body

The cell body 2 is disposed on the support substrate 3. The cell body 2 is supported by the support substrate 3. The cell body 2 is disposed on the support substrate 3 to cover a plurality of through holes 33 (to be described). The cell body 2 includes a hydrogen electrode 21 (cathode), an electrolyte 22, a reaction preventing layer 23, and an oxygen electrode 24 (anode).

The hydrogen electrode 21, the electrolyte 22, the reaction preventing layer 23, and the oxygen electrode 24 are laminated in this order from the support substrate 3 side along the Z-axis direction. The hydrogen electrode 21, the electrolyte 22, and the oxygen electrode 24 are essential components; however, the reaction preventing layer 23 is a component provided on an arbitrary basis.

### Hydrogen Electrode

The hydrogen electrode 21 is disposed on a first principal surface 31 of the support substrate 3. The hydrogen electrode 21 is supplied with raw material gas via each of the through holes 33 of the support substrate 3. The raw material gas contains at least water vapor (H₂O). The hydrogen electrode 21 generates H₂ with electrolytic reactions.

When the raw material gas contains only H₂O, the hydrogen electrode 21 generates H₂ from the raw material gas by electrochemical reactions of water electrolysis expressed in the following formula (1).

Hydrogen electrode 21: H₂O+2e⁻→H₂+O²⁻ (1)

When the raw material gas contains CO₂ in addition to H₂O, the hydrogen electrode 21 generates H₂, CO, and O²⁻ from the raw material gas by electrochemical reactions of co-electrolysis expressed in the following formulae (2), (3), and (4).

Hydrogen electrode 21: CO₂+H₂O+4e⁻→CO+H₂+2O²⁻ (2)

Electrochemical reaction of H₂O: H₂O+2e⁻→H₂+O₂ (3)

Electrochemical reaction of CO₂: CO₂+2e⁻→CO+O²⁻ (4)

H₂ generated in the hydrogen electrode 21 flows out via each of the through holes 33 of the support substrate 3 to an internal space 30 (to be described).

The hydrogen electrode 21 is a porous body with electronic conductivity. The hydrogen electrode 21 contains nickel (Ni). In co-electrolysis, Ni not only functions as an electron transmitter but also functions as a thermal catalyst that maintains a gas composition appropriate for methanation, FT (Fischer-Tropsch) synthesis, and so forth by promoting thermal reactions between H₂ to be generated and CO₂ contained in the raw material gas. During operating the electrolytic cell 100, Ni contained in the hydrogen electrode 21 basically exists in a state of metal (Ni) but may exist in part in a state of nickel oxide (NiO).

The hydrogen electrode 21 may contain an ionic conductive material. For example, the following can be used as the ionic conductive material: one selected from the group of yttria-stabilized zirconia (YSZ), calcia-stabilized zirconia (CSZ), scandia-stabilized zirconia (ScSZ), gadolinium-doped ceria (GDC), samarium-doped ceria (SDC), (La, Sr) (Cr, Mn)O₃, (La, Sr)TiO₃, Sr₂(Fe, Mo)₂O₆, (La, Sr)VO₃, and (La, Sr)FeO₃, a mixed material obtained by a combination of two or more of the group, or so forth.

The hydrogen electrode 21 is not particularly limited in thickness, and hence, can be set to have a thickness of, for instance, greater than or equal to 1 μm and less than or equal to 100 μm. The hydrogen electrode 21 is not particularly limited in thermal expansion coefficient, and hence, can be set to have a thermal expansion coefficient of, for instance, greater than or equal to 12×10⁻⁶/° C. and less than or equal to 12×10⁻⁶/° C.

The hydrogen electrode 21 is not particularly limited in method of formation, and hence, can be formed by any of the methods such as firing, spray coating (thermal spraying, aerosol deposition, aerosol gas deposition, powder jet deposition, particle jet deposition, cold spraying, etc.), PVD (spattering, pulse laser deposition, etc.), and CVD.

### Electrolyte

The electrolyte 22 is formed on the hydrogen electrode 21. The electrolyte 22 is disposed between the hydrogen electrode 21 and the oxygen electrode 24. In the present preferred embodiment, the electrolyte 22 is connected to both the hydrogen electrode 21 and the reaction preventing layer 23, while being interposed therebetween.

The electrolyte 22 not only covers the hydrogen electrode 21 but also covers a region, exposed without being covered with the hydrogen electrode 21, on the first principal surface 31 of the support substrate 3.

The electrolyte 22 is a dense body with oxide ionic conductivity. The electrolyte 22 transmits 02-, generated in the hydrogen electrode 21, to the oxygen electrode 24 side. The electrolyte 22 is made of an oxide ionic conductive material. The electrolyte 22 can be made of, for instance, YSZ, GDC, ScSZ, SDC, LSGM (lanthanum gallate), or so forth but is preferably made of YSZ.

The electrolyte 22 is not particularly limited in thickness, and hence, can be set to have a thickness of, for instance, greater than or equal to 1 μm and less than or equal to 100 μm. The electrolyte 22 is not particularly limited in thermal expansion coefficient, and hence, can be set to have a thermal expansion coefficient of, for instance, greater than or equal to 10×10⁻⁶/° C. and less than or equal to 12×10⁻⁶/° C.

The electrolyte 22 is not particularly limited in method of formation, and hence, can be formed by any of the methods such as firing, spray coating, PVD, and CVD.

### Reaction Preventing Layer

The reaction preventing layer 23 is disposed between the electrolyte 22 and the oxygen electrode 24. The reaction preventing layer 23 is disposed on the opposite side of the electrolyte 22 from the side on which the hydrogen electrode 21 is disposed, with reference to the electrolyte 22. The reaction preventing layer 23 inhibits a layer with high electric resistance from being formed by reactions between the element of which the electrolyte 22 is made and the element of which the oxygen electrode 24 is made.

The reaction preventing layer 23 is made of an oxide ionic conductive material. The reaction preventing layer 23 can be made of GDC, SDC, or so forth.

The reaction preventing layer 23 is not particularly limited in porosity, and hence, can be set to have a porosity of, for instance, greater than or equal to 0.1% and less than or equal to 50%. The reaction preventing layer 23 is not particularly limited in thickness, and hence, can be set to have a thickness of, for instance, greater than or equal to 1 μm and less than or equal to 50 μm.

The reaction preventing layer 23 is not particularly limited in method of formation, and hence, can be formed by any of the methods such as firing, spray coating, PVD, and CVD.

### Oxygen Electrode

The oxygen electrode 24 is disposed on the opposite side of the electrolyte 22 from the side on which the hydrogen electrode 21 is disposed, with reference to the electrolyte 22. In the present preferred embodiment, the reaction preventing layer 23 is disposed between the electrolyte 22 and the oxygen electrode 24; hence, the oxygen electrode 24 is connected to the reaction preventing layer 23. When the reaction preventing layer 23 is not disposed between the electrolyte 22 and the oxygen electrode 24, the oxygen electrode 24 is connected to the electrolyte 22.

The oxygen electrode 24 generates O₂ from O²⁻ transmitted thereto from the hydrogen electrode 21 via the electrolyte 22 by chemical reactions expressed by the following formula (5).

Oxygen electrode 24: 2O²⁻→O₂+4e⁻ (5)

The oxygen electrode 24 is a porous body with oxide ionic conductivity and electronic conductivity. The oxygen electrode 24 can be made of, for instance, a composite material composed of an oxide ionic conductive material (GDC, etc.) and at least one selected from the group consisting of (La, Sr) (Co, Fe)O₃, (La, Sr)FeO₃, La (Ni, Fe)O₃, (La, Sr)CoO₃, and (Sm, Sr)CoO₃.

The oxygen electrode 24 is not particularly limited in porosity, and hence, can be set to have a porosity of, for instance, greater than or equal to 20% and less than or equal to 60%. The oxygen electrode 24 is not particularly limited in thickness, and hence, can be set to have a thickness of, for instance, greater than or equal to 1 μm and less than or equal to 100 μm.

The oxygen electrode 24 is not particularly limited in method of formation, and hence, can be formed by any of the methods such as firing, spray coating, PVD, and CVD.

### Support Substrate

As shown in FIG. 2, the support substrate 3 supports the cell body 2. In the present preferred embodiment, the support substrate 3 is made in shape of a plate. Insomuch as the cell body 2 can be supported by the support substrate 3, the support substrate 3 is not particularly limited in thickness, and hence, can be set to have a thickness of, for instance, greater than or equal to 0.1 mm and less than or equal to 2.0 mm.

The raw material gas to be supplied to the cell body 2 and reducing gas (H₂ in the present preferred embodiment) to be generated in the hydrogen electrode 21 flow inside the internal space 30 defined by the support substrate 3 and the inter-connector 4.

The support substrate 3 includes the first principal surface 31, a second principal surface 32, and the plural through holes 33. In the present preferred embodiment, the first principal surface 31 is the upper surface of the support substrate 3, whereas the second principal surface 32 is the lower surface of the support substrate 3. The first principal surface 31 faces the cell body 2. The second principal surface 32 faces the inter-connector 4.

Each of the through holes 33 is configured to cause gas to permeate therethrough. Each through hole 33 penetrates the support substrate 3 from the first principal surface 31 to the second principal surface 32. Each through hole 33 is opened on each of the first and second principal surfaces 31 and 32. Because of this, gas permeates through the support substrate 3 via the through holes 33.

Each through hole 33 is covered with the cell body 2. Specifically, the first principal surface 31-side opening of each through hole 33 is covered with the hydrogen electrode 21. The second principal surface 32-side opening of each through hole 33 is connected to the internal space 30.

The respective through holes 33 can be formed by machining processing (e.g., punching), laser processing, chemical processing (e.g., etching), or so forth.

In the present preferred embodiment, each through hole 33 is shaped straight along the Z-axis direction. However, each through hole 33 may slant with respect to the Z-axis direction; besides or alternatively, each through hole 33 may not be shaped straight. Besides or alternatively, the through holes 33 may continue to each other.

The support substrate 3 is made of an alloy containing Cr (Chromium). Fe—Cr-based alloy steel (stainless steel, etc.), Ni—Cr-based alloy steel, or so forth can be exemplified as the alloy herein described. The support substrate 3 is not particularly limited in content rate of Cr, and hence, can be set to contain Cr at a content rate of greater than or equal to 4 mass % and less than or equal to 30 mass %.

The support substrate 3 may contain Ti (Titanium) and Zr (Zirconium). The support substrate 3 is not particularly limited in content rate of Ti, and hence, can be set to contain Ti at a content rate of greater than or equal to 0.01 mol % and less than or equal to 1.0 mol %. The support substrate 3 is not particularly limited in content rate of Zr, and hence, can be set to contain Zr at a content rate of greater than or equal to 0.01 mol % and less than or equal to 0.4 mol %. The support substrate 3 may contain Ti in the form of TiO₂ (titania) and may contain Zr in the form of ZrO₂ (zirconia).

### Inter-Connector

The inter-connector 4 is disposed on the same side as the second principal surface 32 of the support substrate 3. The inter-connector 4 is a member for electrically connecting the electrolytic cell 100 to either an external power source or another electrolytic cell.

The inter-connector 4 is made in shape of a plate. The inter-connector 4 is attached to the support substrate 3. The inter-connector 4 is fixed at the outer peripheral part thereof to the support substrate 3. The inter-connector 4 is fixed to the support substrate 3 by, for instance, welding or bonding. The inter-connector 4 includes a body 40, a first oxide layer 41, and a second oxide layer 42.

The body 40 is made in shape of a plate. The body 40 is not particularly limited in thickness, and hence, can be set to have a thickness of, for instance, greater than or equal to 0.1 mm and less than or equal to 2.0 mm. The outer peripheral part of the body 40 protrudes toward the support substrate 3. The outer peripheral part of the body 40 defines the outer circumference of the internal space 30. It should be noted that the outer peripheral part of the body 40 may be provided as a member separated from the body 40.

The body 40 includes a first principal surface 401, a second principal surface 402, a plurality of first protrusions 403, and a plurality of second protrusions 404. The first principal surface 401 is a surface facing the support substrate 3. The second principal surface 402 is opposite to the first principal surface 401. In other words, the second principal surface 402 faces the opposite side of a direction in which the first principal surface 401 faces. In the present preferred embodiment, the first principal surface 401 is the upper surface of the body 40, whereas the second principal surface 402 is the lower surface of the body 40.

Each of the first protrusions 403 is provided on the first principal surface 401 of the body 40. Each first protrusion 403 protrudes toward the support substrate 3. Each first protrusion 403 is disposed inside the internal space 30. Each first protrusion 403 is not particularly limited in height, and hence, can be set to have a height of, for instance, greater than or equal to 0.1 mm and less than or equal to 2.0 mm.

Each of the second protrusions 404 protrudes to the opposite side to each first protrusion 403. Each second protrusion 404 is not particularly limited in height, and hence, can be set to have a height of, for instance, greater than or equal to 0.1 mm and less than or equal to 2.0 mm.

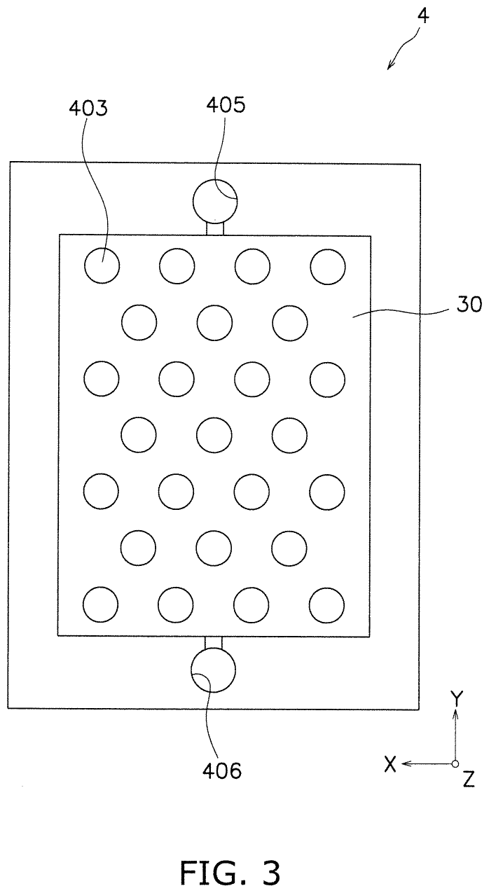

FIG. 3 is a plan view of the inter-connector 4. It should be noted that for easy understanding of the drawing, FIG. 3 illustrates only the first protrusions 403 without illustrating recesses to be actually observed as the back surfaces of the second protrusions 404. As shown in FIG. 3, the first protrusions 403 are disposed away from each other at intervals. Specifically, the first protrusions 403 are aligned in a staggered shape. The respective first protrusions 403 can be formed by processing the inter-connector 4 by stamping, cutting, etching, or so forth. It should be noted that the respective second protrusions 404 are configured in comparable manner to the respective first protrusions 403.

Each first protrusion 403 is larger than each through hole 33 in a plan view. Because of this, in the plan view, two or more of the plural through holes 33 overlap with each first protrusion 403.

The inter-connector 4 includes a supply hole 405 and a discharge hole 406. The supply hole 405 and the discharge hole 406 are communicated with the internal space 30. The supply hole 405 penetrates the inter-connector 4 in the Z-axis direction. The raw material gas, supplied to the electrolytic cell 100 from an external gas supply source, flows through the supply hole 405 in the Z-axis direction. The raw material gas is supplied to the interior of the internal space 30 via the supply hole 405.

The discharge hole 406 penetrates the inter-connector 4 in the Z-axis direction. H₂, which is generated in the hydrogen electrode 21 and flows through the internal space 30, is discharged to the outside via the discharge hole 406 and is recovered on the outside.

As shown in FIG. 2, the body 40 is made of an alloy containing Cr. Fe—Cr-based alloy steel, Ni—Cr-based alloy steel, or so forth can be exemplified as the alloy herein described. The body 40 is not particularly limited in content rate of Cr, and hence, can be set to contain Cr at a content rate of greater than or equal to 4 mass % and less than or equal to 30 mass %. The body 40 may be identical in composition to or different in composition from the support substrate 3.

The first oxide layer 41 is disposed on the first principal surface 401 of the body 40. It should be noted that the first oxide layer 41 is not disposed on the outer peripheral part of the first principal surface 401, but alternatively, may be disposed thereon. The first oxide layer 41 is in contact with the support substrate 3. The first oxide layer 41 is different in thermal expansion coefficient from the body 40. In the present preferred embodiment, the first oxide layer 41 is smaller in thermal expansion coefficient than the body 40. The first oxide layer 41 is made of an oxide containing Cr as a primary component (hereinafter abbreviated as “Cr oxide”). Accordingly, during manufacturing or operating the electrolytic cell 100, Cr can be inhibited from diffusing from the support substrate 3 and the body 40 to the first oxide layer 41. Besides, even if Cr diffuses from the support substrate 3 and the body 40 to the first oxide layer 41, the diffused Cr is not so much as affecting the composition of the first oxide layer 41; hence, deterioration in strength of the first oxide layer 41 can be inhibited as well.

It should be noted that in the present preferred embodiment, “the Cr oxide, of which the first oxide layer 41 is made, contains Cr as the primary component” means that Cr is the highest in content rate among metallic elements of the Cr oxide when the composition of the Cr oxide is analyzed by an energy dispersive spectrometer (EDS). The Cr oxide is not particularly limited in content rate of Cr among the metallic elements, and hence, can be set to contain Cr at a content rate of, for instance, greater than or equal to 20 mol % and less than or equal to 100 mol %.

The Cr oxide, of which the first oxide layer 41 is made, preferably contains Cr among the metallic elements thereof at a content rate of greater than or equal to 50 mol %. Accordingly, Cr contained in the support substrate 3 and the body 40 can be remarkably inhibited from diffusing to the first oxide layer 41.

The Cr oxide, of which the first oxide layer 41 is made, is preferably composed of at least either chromium oxide or chromium manganese oxide. The oxides herein described have properties that Cr is especially unlikely to diffuse; hence, the first oxide layer 41 can be thereby enhanced in durability.

Cr₂O₃ or so forth can be exemplified as the chromium oxide. MnCr₂O₄ (spinel), Mn_{1.5}Cr_{1.5}O₄ (spinel), or so forth can be exemplified as the chromium manganese oxide.

The Cr oxide, of which the first oxide layer 41 is made, is preferably crystalline. Because of this, even if the electrolytic cell 100 is operated for a long period of time, it is made possible to avoid occurrence of such a situation that the Cr oxide transitions from a non-crystalline phase to a crystalline phase, whereby the first oxide layer 41 is undesirably damaged or broken.

The Cr oxide, of which the first oxide layer 41 is made, preferably has either a spinel crystal structure or a corundum crystal structure. The crystal structures herein described are high in symmetry; hence, the first oxide layer 41 can be thereby enhanced in endurance against thermal stress.

The first oxide layer 41 can be formed by applying a paste containing the Cr oxide onto the first principal surface 401 of the body 40, and then, by conducting a thermal treatment. Conditions for the thermal treatment can be arbitrarily set but the following can be set as exemplary conditions for the thermal treatment: a temperature of greater than or equal to 600° C. and less than or equal to 1100° C. and a duration of greater than or equal to 0.5 hours and less than or equal to 24 hours.

The second oxide layer 42 is disposed on the second principal surface 402 of the body 40. When the electrolytic cell 100 is laminated on another electrolytic cell in the form of a cell stack, the second oxide layer 42 is in contact with a cell body (omitted in illustration) of the electrolytic cell disposed thereunder. The second oxide layer 42 is different in thermal expansion coefficient from the body 40. In the present preferred embodiment, the second oxide layer 42 is smaller in thermal expansion coefficient than the body 40. Specifically, the second oxide layer 42 is substantially equal in thermal expansion coefficient to the first oxide layer 41. The second oxide layer 42 is made of an oxide containing Cr as a primary component.

The second oxide layer 42 is made of a material substantially identical to that of the first oxide layer 41 described above; hence, the material of the second oxide layer 42 will be omitted in detailed explanation.

The first oxide layer 41 is smaller in thickness than the cell body 2. The second oxide layer 42 is smaller in thickness than the cell body 2. The first oxide layer 41 can be set to have a thickness of, for instance, greater than or equal to 0.1 μm and less than or equal to 20 μm. On the other hand, the second oxide layer 42 can be set to have a thickness of, for instance, greater than or equal to 0.12 μm and less than or equal to 100 μm.

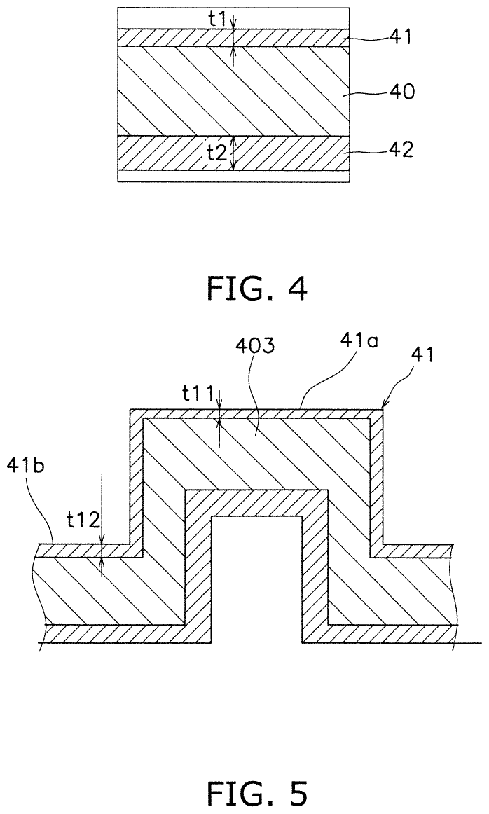

As shown in FIG. 4, the first oxide layer 41 is different in thickness from the second oxide layer 42. Specifically, the first oxide layer 41 is smaller in thickness than the second oxide layer 42. Specifically, a ratio (t2/t1) of the thickness (t2) of the second oxide layer 42 to the thickness (t1) of the first oxide layer 41 can be set to be greater than or equal to 1.2. Besides, the ratio (t2/t1) of the thickness (t2) of the second oxide layer 42 to the thickness (t1) of the first oxide layer 41 can be set to be less than or equal to 20.

The thickness of the first oxide layer 41 and that of the second oxide layer 42 can be measured as follows. First, in order to create such a cross section as shown in FIG. 2, the inter-connector 4 is cut by an imaginary plane that is oriented along a width direction (the X-axis direction) to pass through the center of the inter-connector 4. Then, in the vicinity of the middle of the cross section, each of the first and second oxide layers 41 and 42 is scanned (photographed) by a scanning electron microscopy (SEM) at a magnification (of 200-fold to 20000-fold) suitable for measurement of thickness in order to obtain a plurality of scanned images.

Subsequently, measurement points are set for equally dividing each of the images scanned by the SEM into ten sections in the width direction; then, the thickness of the first oxide layer 41 and that of the second oxide layer 42 are measured at the measurement points, respectively. The average of values of the thickness of the first oxide layer 41 at the measurement points can be set as the thickness t1 of the first oxide layer 41; likewise, the average of values of the thickness of the second oxide layer 42 at the measurement points can be set as the thickness t2 of the second oxide layer 42. It should be noted that the thickness t1 and the thickness t2 are measured if both the first and second oxide layers 41 and 42 extend in the X-axis direction at a given one of the measurement points. Specifically, if at least either of the first and second oxide layers 41 and 42 extends in the Z-axis direction at a given one of the measurement points equally dividing each scanned image into the ten sections, the thickness t1 and the thickness t2 are measured at another measurement point, which is closest to the given measurement point, and in which both the first and second oxide layers 41 and 42 extend in the X-axis direction.

FIG. 5 is an enlarged cross-sectional view of each first protrusion 403 of the inter-connector 4. As shown in FIG. 5, the first oxide layer 41 includes first portions 41a disposed on the first protrusions 403 and second portions 41b disposed on the remainder thereof other than the first protrusions 403. The thickness (t11) of each first portion 41a is smaller than the thickness (t12) of each second portion 41b. Because of this, increase in magnitude of electric resistance can be inhibited between the inter-connector 4 and the support substrate 3.

The thickness t11 of each first portion 41a and the thickness t12 of each second portion 41b can be measured in the following method. First, in order to create such a cross section as shown in FIG. 2, the inter-connector 4 is cut by an imaginary plane that is oriented along the width direction (the X-axis direction) to pass through two or more of the plural first protrusions 403 in the vicinity of the center of the inter-connector 4. Then, in the vicinity of the middle of the cross section, each of the first and second portions 41a and 41b is scanned (photographed) by the scanning electron microscopy (SEM) at a magnification (of 200-fold to 20000-fold) suitable for measurement of the thickness of the first oxide layer 41. It should be noted that as shown in FIG. 5, the first and second portions 41a and 41b disposed in adjacent to each other are selected for scanning. The second portion 41b is measured in thickness in a range from the first protrusion 403, provided with the first portion 41a to be measured in thickness, to a position away therefrom by the width of the first protrusion 403.

The thickness of the first portion 41a of the first oxide layer 41 is measured at an arbitrary plurality of points (e.g., ten points); then, the average of values of the thickness of the first portion 41a at the points can be set as the thickness t11 of the first portion 41a. Likewise, the thickness t12 of the second portion 41b of the first oxide layer 41 is measured at an arbitrary plurality of points (e.g., ten points); then, the average of values of the thickness of the second portion 41b at the points can be set as the thickness t12 of the second portion 41b.

In the inter-connector 4 configured as described above, the first oxide layer 41 is smaller in thickness than the second oxide layer 42. Because of this, when the first and second oxide layers 41 and 42 are reduced in temperature to the room temperature after formed, the inter-connector 4 is warped downward by a thermal stress generated therein. As a result, when the electrolytic cell 100 is laminated on another electrolytic cell in the form of a cell stack, it is made possible for the inter-connector 4 to be in reliably contact with the electrolytic cell disposed thereunder. It should be noted that, when the inter-connector 4 is warped downward, this means that the inter-connector 4 is warped to protrude downward at the middle thereof.

### Modifications

One preferred embodiment of the present invention has been explained above. However, the present invention is not limited to this, and a variety of changes can be made without departing from the gist of the present invention.

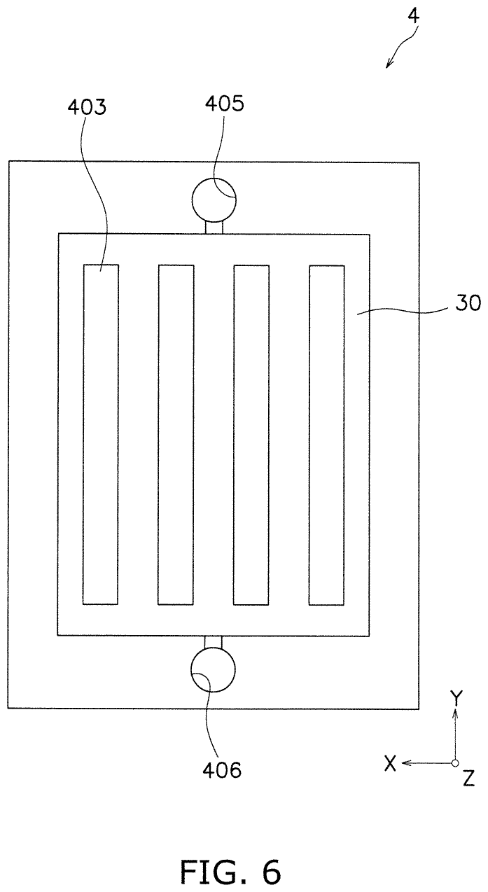

(a) In the preferred embodiment described above, each first protrusion 403 has a circular shape in the plan view; however, each first protrusion 403 is not limited in shape to this. For example, as shown in FIG. 6, each first protrusion 403 may have a rectangular shape in the plan view. Each first protrusion 403 may be elongated in either the Y-axis direction or the X-axis direction. It should be noted that in a comparable manner to each first protrusion 403, each second protrusion 404 may have a rectangular shape in the plan view.

(b) In the preferred embodiment described above, the first oxide layer 41 is configured to be smaller in thickness than the second oxide layer 42; however, the inter-connector 4 is not limited in configuration to this. For example, the first oxide layer 41 may be configured to be larger in thickness than the second oxide layer 42. In this case, when it is intended to warp the inter-connector 4 to protrude downward, each of the first and second oxide layers 41 and 42 is set to be larger in thermal expansion coefficient than the body 40.

(c) In the preferred embodiment described above, the inter-connector 4 is configured to be warped downward; however, the inter-connector 4 is not limited in configuration to this. Specifically, the inter-connector 4 may be configured to be warped upward. In this case, for instance, each of the first and second oxide layers 41 and 42 is set to be smaller in thermal expansion coefficient than the body 40; besides, the first oxide layer 41 is configured to be larger in thickness than the second oxide layer 42. Alternatively, each of the first and second oxide layers 41 and 42 is set to be larger in thermal expansion coefficient than the body 40; besides, the first oxide layer 41 is configured to be smaller in thickness than the second oxide layer 42.

(d) In the preferred embodiment described above, the electrochemical cell is exemplified by the electrolytic cell but is not limited thereto. The electrochemical cell is a generic term for referring to a device for changing electric energy into chemical energy, in which a pair of electrodes is disposed to generate an electromotive force from entire oxidoreduction reactions, and a device for changing chemical energy into electric energy. Therefore, for instance, a fuel battery, in which oxide ions or protons act as carriers, is also considered as the electrochemical cell.

### REFERENCE SIGNS LIST

2: Cell body
3: Support substrate
31: First principal surface
32: Second principal surface
4: Inter-connector
40: Body
401: First principal surface
402: Second principal surface
403: First protrusion
41: First oxide layer
42: Second oxide layer
100: Electrolytic cell

1. An inter-connector comprising:
a body including a first principal surface and a second principal surface, the second principal surface opposite to the first principal surface;
a first oxide layer disposed on the first principal surface; and
a second oxide layer disposed on the second principal surface, the second oxide layer different in thickness from the first oxide layer.

2. The inter-connector according to claim 1, wherein
the body is made of an alloy containing chromium, and
each of the first and second oxide layers contains chromium as a primary component thereof.

3. The inter-connector according to claim 1, wherein each of the first and second oxide layers is smaller in thermal expansion coefficient than the body.

4. The inter-connector according to claim 3, wherein the first oxide layer is smaller in thickness than the second oxide layer.

5. The inter-connector according to claim 1, wherein
the body includes a protrusion on the first principal surface thereof, and
the first oxide layer formed on the protrusion is smaller in thickness than the first oxide layer formed on a part other than the protrusion.

6. An electrochemical cell comprising:
the inter-connector recited in claim 1;
a support substrate attached to the inter-connector; and
a cell body disposed on the support substrate.

7. The electrochemical cell according to claim 6, wherein each of the first and second oxide layers is smaller in thickness than the cell body.
